(19) United States
(12) Patent Application Publication
(10) Pub. No.: US 2008/0248669 A1
(43) Pub. Date: Oct. 9, 2008

(54) HIGH VOLTAGE ELECTRICAL CONNECTORS

(76) Inventors: Kenneth E. Wing, Alpine, CA (US); Scott T. Carroll, Lakeside, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 12/098,424

(22) Filed: Apr. 5, 2008

Related U.S. Application Data
(60) Provisional application No. 60/922,168, filed on Apr. 6, 2007.

(51) Int. Cl. H01R 4/60

(52) U.S. Cl. 439/207

(57) ABSTRACT

The present invention is directed to a connector housing for high voltage wires, either single ended or double ended with an integrated connector. Other features of the present invention include integration of a deep recessed high voltage connector contact for an arc and leakage resistant high voltage connection point, use of a female socket pin embedded at the base of the connector. The socket pin is co-molded into the connection end of the body, or it is co-molded or press fitted into a hole at the end of the connector housing.

This US Non-provisional patent application claims the benefit of U.S. Provisional Patent Application Ser. No. 60/922,168 filed on Apr. 6, 2007.

### FIELD OF THE INVENTION

The present invention generally relates to the field of high voltage connectors for the purpose of connecting high voltage electricity from a power supply source device to a load. More specifically, this patent deals with cost effective high voltage connectors for this purpose, and relates to a convenient and expedient means to join or repair high voltage wires post installation in a cost effective manner.

### BACKGROUND OF THE INVENTION

An accepted definition of the term “high voltage” is any voltage over 42 volts (V). This level has been established by worldwide safety agencies as the level at above which normal dry human skin contact may result in injury. Typical “high voltage” power supplies in the electronics realm operate in the thousands of volts area; especially in the electrostatics industries, where voltages may be in the tens of thousands, but the current is very low, in micro-amps or milli-amps.

Connecting high voltage electricity from a power supply source device to a load has long been problematic, as voltages above about 300V may cause air surrounding the conductor to break down, or ionize, into damage-causing corona and arcing.

Many styles of high voltage connectors for this purpose have been developed. They typically consist of a long “male” connector part and a deeply recessed female counterpart. They may include O rings or other devices to effectively seal the air around the contact point. By their nature, these connectors consist of many individual parts, requiring many manufacturing steps. They are as such relatively expensive, pricing them out of range of the typical low cost high voltage electrostatic or other high voltage product application.

Currently, high voltage connections require long tracking distances with insulating material to prevent corona and electron leakage from the point of connection. This is most often done by deeply recessing a contact point at the base of a long tunnel of insulating material to form the “female” contact, with the male contact being a long conductor point insulated by an appropriate material, except at the point of connection at the bottom of the tunnel. These connectors tend to be expensive and space consuming. Therefore, it would be highly desirable to have a connection tunnel that is integrated into the power source or encapsulated within over-molding material.

### SUMMARY OF THE INVENTION

It is the primary object of the present invention to provide a high voltage connector arrangement having improved performance and reduced cost for connecting high voltage wires in a simple and cost effective manner.

Another object of this invention is to create a method that will simplify the manufacturing of said high voltage connector units, with appropriate process and material, resulting in a low cost high voltage wire connector unit.

Another object of this invention is to create a resultant high voltage wire connector unit in which the wire connection is fully protected from the environment, and also, by the use of the proper techniques, the high voltage wires inside are fully encapsulated and insulated from each other, preventing internal arcing that would damage the parts.

The present low cost gas and liquid tight high voltage electrical connector invention is novel in that it has no dedicated male portion of the connector. Therefore it is desirable to integrate the high voltage wire itself as it becomes the male portion of the connector, saving significant parts cost. The wire may or may not have an added “pin” on the end of the wire to contact the female portion of the connector.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

In a preferred high voltage wire splice embodiment, the system provides an inexpensive and expedient means to join or repair high voltage wires post installation. Generic watertight cord grips are used on the outside of the connector body as an environmental seal around a variety of high voltage wire diameters.

A first alternate embodiment of the novel low cost gas and liquid tight high voltage electrical connectors includes a connector designed for non-encapsulated operation.

A second alternate embodiment of the novel low cost gas and liquid tight high voltage electrical connectors has the wire pre-attached to the female socket pin and co-molded into the connector body, so the connector may be considered a “stand alone” and unpotted device.

A third alternate embodiment of the novel low cost gas and liquid tight high voltage electrical connectors utilizes silicone dielectric grease that may be applied at the contact area and the seal area to enhance corona free operation at very high voltages. This use of dielectric grease at the contact point is highly advantageous with extremely high voltages.

It must be clearly understood at this time although the preferred embodiment of the invention consists of the over-molded female socket pin with poke-home style connector, that many other configurations exist, including any number of high voltage connectors, requiring a safe and efficient high voltage delivery to numerous configurations of contacts, or other combinations thereof, that will achieve the a similar operation, and they will also be fully covered within the scope of this patent.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a side elevational view of a double ended high voltage connector device, constructed in accordance with the present invention;

FIG. 2 depicts a cross-sectional view of the high voltage connector illustrating the component parts, constructed in accordance with the present invention;

FIG. 3 is a side elevational view of a panel mount high voltage connector device with a section of the female socket pin exposed so a wire may be attached to the female socket pin prior to potting the connector with the power supply unit or other device, constructed in accordance with the present invention;

FIG. 4 illustrates a cross sectional elevational view of a panel mount high voltage connector device with a section of the female socket pin exposed so a wire may be attached to the female socket pin prior to potting the connector with the power supply unit or other device, constructed in accordance with the present invention;

FIG. 5 depicts an exploded perspective view of the panel mount high voltage connector device, illustrating the connector body as it would be connected to the watertight cord grip, constructed in accordance with the present invention;

FIG. 6 shows a side elevational view of a high voltage connector device illustrating the connector body, single ended and over-molded, an insulated wire, compression nut, and gland body, constructed in accordance with the present invention;

FIG. 7 depicts a cross sectional view of the connector body, single ended, illustrating the insulated wire, a female socket pin which is over-molded and is introduced into the single ended connector body, constructed in accordance with the present invention;

FIG. 8 is a perspective view of a single ended over-molded high voltage connector device body, with insulated wire, an embodiment of the single ended over-molded connector body with an integrated compression nut connector, constructed in accordance with the present invention; and

FIG. 9 is a cross sectional view of a high voltage connector splice device housing, double ended, with compression nuts, and illustrating the application location of dielectric grease with in said housing, constructed in accordance with the present invention.

For a fuller understanding of the nature and objects of the invention, reference should be had to the following detailed description taken in conjunction with the accompanying drawings which are incorporated in and form a part of this specification, illustrate embodiments of the invention and together with the description, serve to explain the principles of this invention.

### DETAILED DESCRIPTION OF THE PREFERRED EMBODIMENTS

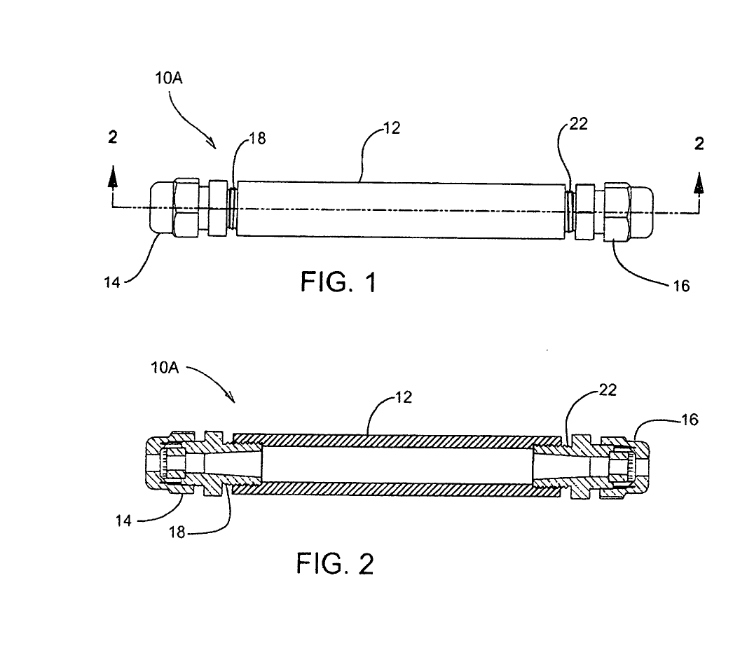

Referring now to FIG. 1, FIG. 1 depicts a side elevational view of a double ended high voltage splice connector device 10A. The connector housing 12 is attached to a gland 18 and 22, at each end. A compression nut 14 and 16 is mounted at the distal portions of the connector housing 12 by the glands 18 and 22. This unit is designed for non-encapsulated operation. Also, this double-ended high voltage splice connector device 10A is optimally suited for repair applications.

FIG. 2 depicts a cross-sectional view of the high voltage connector 10A illustrating the compression nuts 14 and 16 and the double ended connector housing 12 with gland bodies 18 and 22, in greater detail, constructed in accordance with the present invention. The threaded portions of the connector housing 12 accept the threaded portions of each of the glands 18 and 22.

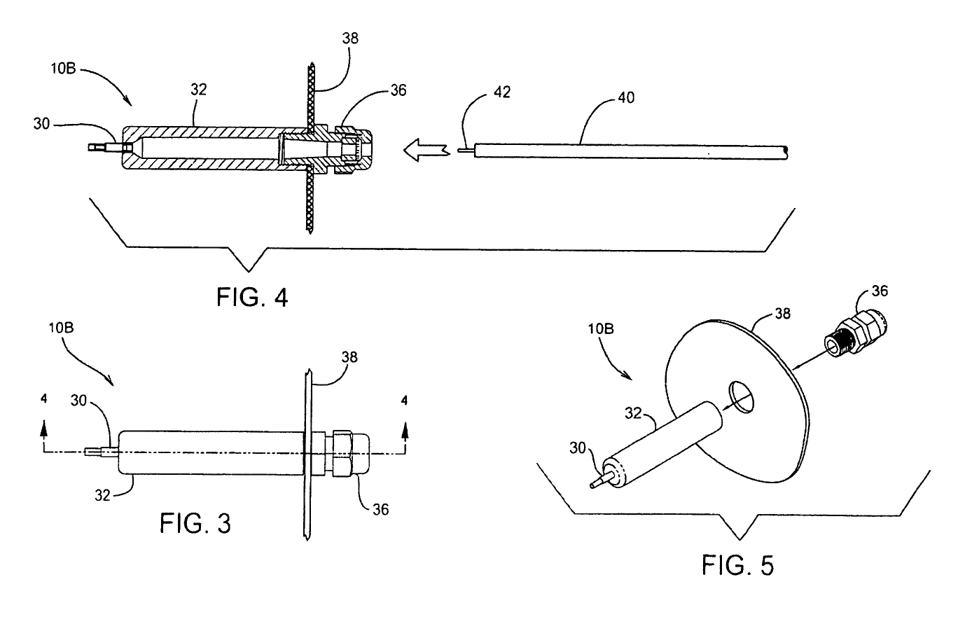

FIG. 3 is a side elevational view of a panel mount high voltage connector device 10B that has the female socket pin 30 encapsulated or press fit into the single ended connector body 32. The female connector pin 30 may be exposed externally to allow connection to a high voltage power source. This connection may be made by means of crimping or soldering, or any other likewise means for connecting. The connector may be considered a “built in” or internally incorporated as 10B may be fully encapsulated. As shown, 10B is fully encapsulated within a power source and the external portion of the watertight cord grip 36 passes through a panel 38. Therefore, device 10B is designed for full encapsulation and in operation is utilized by panel mounting (or chassis box mounting) through a panel 38.

FIG. 4 shows a cross sectional view of a high voltage connector 10B with a section of the female socket pin 30 exposed so a wire may be attached to the female socket pin 30 prior to potting the connector within the power supply unit or other device. It indicates the receptacle for the back section of the female socket pin 30, single ended exposed, so a wire may be attached to the female socket pin 30 prior to potting the connector within the power supply unit or other device. A single ended connector body 32 with watertight cord grip 36, and a portion of panel 38 is depicted. An insulated wire 40 with a stripped end 42 shows the manner in which a male portion of wire is introduced into the female socket end of said high voltage connector 10B. Additionally, this connector 10B may be used with dielectric grease added to the housing prior to insertion of the high voltage wire. The dielectric grease acts to exclude oxygen, and thereby, prevents corona and arcing when extremely high voltages are present.

FIG. 5 depicts a perspective exploded view of the high voltage connector 10B, illustrating the connector body 32 as it would be connected to the watertight cord grip 36 as it is passed through the panel 38. The length of the connector body and the thickness of the wall may be adjusted to suit the voltage levels being utilized with the connector. Typical industry accepted figures are 10,000 volts per inch of interior length, and 200V per mil of wall thickness. A connector designed for 25,000V operation might be about three inches in length with a wall thickness of about 0.15 to 0.19 inches. The inner diameter of the connector needs to suit the typical high voltage wire diameter of approximately 0.2 inches, so it may have a dimension of about 0.25 inches inner diameter. The single ended high voltage connector 10B may be used to safely and efficiently provide for a passage through a portion of panel 38 or other obstacle. The single ended connector body 32 on the interior side of the panel 38 will accommodate the watertight cord grip 36 on the external side of the panel 38.

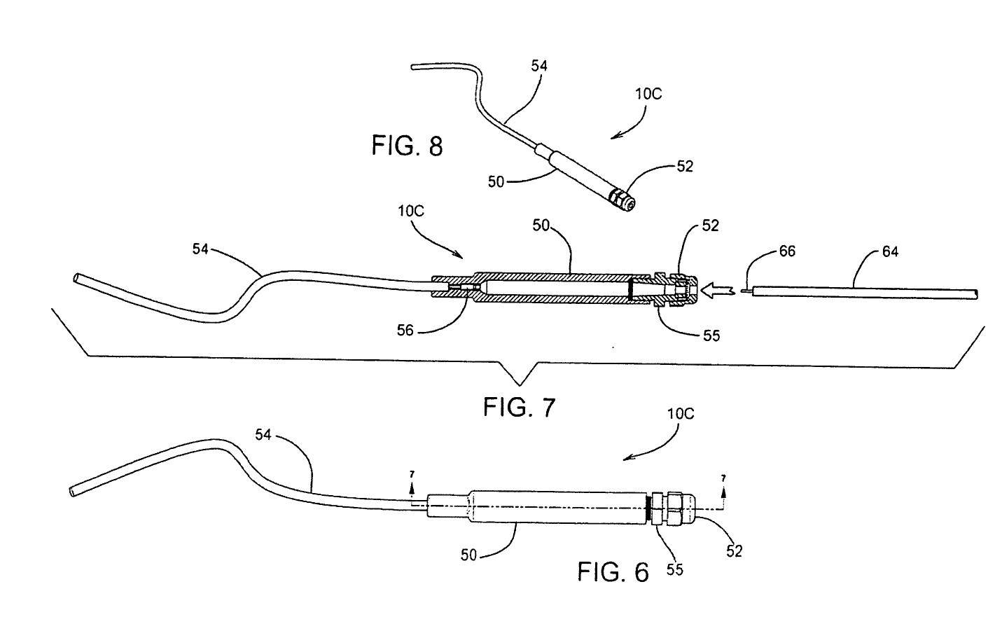

FIG. 6 shows a side elevational view of a high voltage connector device 10C, illustrating the connector body, single ended and over-molded, an insulated wire, compression nut, and gland body, constructed in accordance with the present invention. FIG. 6 shows a connector body 50, single ended with an over-molded female socket pin 56, and an insulated wire 54, compression nut 52, gland body 55. In operation, this single-ended high voltage connector 10C may be a “stand alone” or a potted connector and may or may not employ dielectric grease internally to exclude oxygen from the connection point.

FIG. 7 depicts a cross sectional view through the high voltage connector device 10C shown in FIG. 6, illustrating single ended connector body 50. The insulated wire 54 has a female socket pin 56 which is over-molded and is introduced into the single ended connector body 50. The insulated wire 64 has a stripped end 66 and is inserted into the single ended connector body 50 by a compression nut 55 and gland body 55. Prior to insertion, dielectric grease may be applied internally within connector body 50 at socket 56. The dielectric grease excludes oxygen from the connection point and thereby prevents plasma, corona and arcing, which may act to damage the connection.

FIG. 8 is a perspective view of a single ended over-molded connector body 50, with insulated wire 54. This is an embodiment of the single ended over-molded connector body 10C with an integrated compression nut 52 connector, having the pin 56 and the wire 54 over-molded.

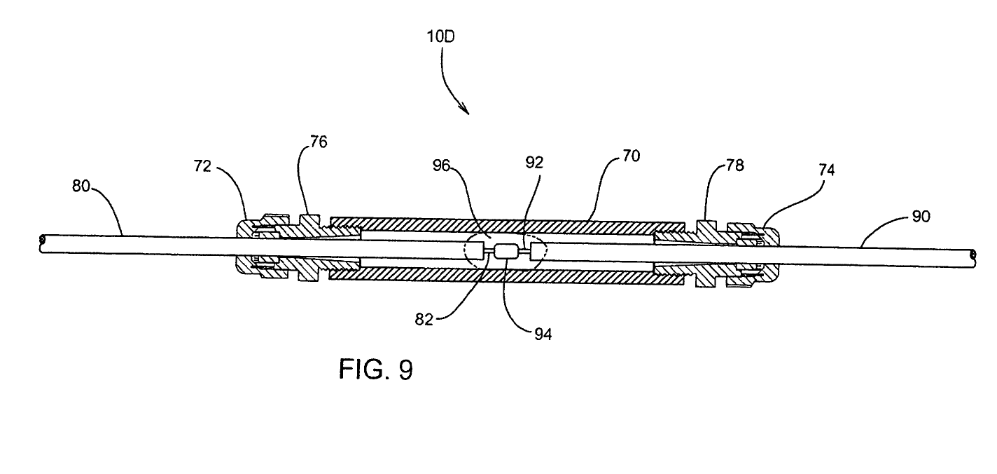

FIG. 9 illustrates a high voltage splice connector device 10D which comprises a double ended connector housing 70 with two compression nuts 72 and 74 and two gland bodies 76 and 78. Gland bodies 76 and 78 and insulated wires 80 and 90 with stripped ends 82 and 92 are included in this cross-sectional view of the double ended connector housing 10D. This illustration shows the wire splice connector 94 and the dielectric grease 96, in greater detail, constructed in accordance with the present invention. In extremely high voltage connection applications, it is highly advantageous to use the dielectric grease to prevent arcing and damage to the connector during operation. The wire splice connector 94 may be a crimped butt splice or may be soldered, or any other likewise means of making a wire connection between two or more wires.

The connector bodies pictured in FIG. 3, FIG. 4, FIG. 5, FIG. 6, FIG. 7, and FIG. 8 all represent a high voltage connector device which has a connector body that is single ended and may be over-molded. FIG. 1, FIG. 2, and FIG. 9 are designed for unencapsulated wire joining operation or field repair applications. Embodiments 10A and 10D illustrate the double ended connector housing. Embodiment 10B shows a single ended connector body with an externally exposed the female socket pin for fully encapsulated operation. Embodiment 10C shows a single ended connector body with a wire pre-attached to the female socket pin and co-molded into the connector body, so the connector may be considered a “stand alone” and unpotted device. FIG. 3, FIG. 4 and FIG. 5 shows the back section of the female socket pin exposed so a wire may be attached to the female socket pin prior to potting the connector with the power supply unit or other device.

The length of the connector body and the thickness of the wall may be adjusted to suit the voltage levels being utilized with the connector. Typical industry accepted figures are 10,000 volts per inch of interior length, and 200V per mil of wall thickness. A connector designed for 25,000V operation might be three inches in length with a wall thickness of about 0.15 to about 0.19 inches. The inner diameter of the connector needs to suit the typical high voltage wire diameter of approximately 0.2 inches, so it may have a dimension of about 0.25 inches inner diameter.

The female socket pin imbedded at the base of the connector is typically a Mill-Max 0370 style or equivalent part. The socket pin in embodiment 10C is co-molded into the connection end of the body in the case of the single ended bodies, or it is press fit or co-molded into a hole at the end of the body such as in embodiment 10B.

The exterior liquid tight bushing utilized at the opening of the connector body is typically a Heyco Liquid Tight Strain Relief Gland, style M3444 or equivalent part. The open end of the connector body is fashioned with an interior thread to match and mate with the bushing's threads. The connector may be mounted into a chassis or box by means of placing the barrel part of the connector on the inside of the box or panel, and inserting and threading the bushing part of the connector through the chassis wall onto the barrel, thus mounting the connector to the panel as illustrated in FIG. 3, FIG. 4 and FIG. 5. Likewise the co-molded connector 10C as shown in FIG. 6, FIG. 7 and FIG. 8 may be panel mounted as well.

High voltage wire for tens of thousands of volts operation is typically 0.15 to 0.22 inches, outside diameter, and is relatively stiff. This stiffness allows the wire to be pushed into the connector from the outside with relative ease. The wire insulation is first stripped back from the end about 0.2 inches, and a small contact pin of approximately 0.04 inches diameter is attached by crimping or soldering it to the stripped end. Or, if the wire's conductor is approximately the same diameter as the pin, the stripped portion of the wire itself can be tinned with solder to form a stiff “pin” without using an added contact pin.

Optionally, to improve corona resistance of the connection point, a small amount of silicone dielectric grease (such as Loctite Dielectric Grease 30536 or equivalent, approximately 0.1 to 0.2 oz.) may be squirted deep into the connector well. The wire is then inserted through the loosened outer wire gland, and fully inserted into the barrel so the pin engages the socket deep into the connector. The wire gland is then tightened, producing a gas and liquid tight connection.

This device is utilized for splicing two high voltage wires together. FIG. 1, FIG. 2 and FIG. 9 depict a dual ended type connector, consisting of an insulating barrel with a wire gland at each end. The length and wall thickness of the device are selected depending on the voltage to be conducted as before.

One of two the wires is first inserted into a wire gland and the barrel. The other wire gland is slipped over the other wire for later threading into the barrel. The mating ends of each wire are then stripped back approximately 0.25 inch, and are connected together with a crimp butt splice type of crimp connector (3M BSV18 or similar), or other equivalent means (they could be twisted and soldered for instance). Optionally, the splice and the ends of the wires near the splice may be coated liberally and completely with silicone dielectric grease to prevent air contact. The wire in the barrel portion is pulled back so that the splice is centered into the barrel. Then the other wire gland is slid into place and threaded on the barrel, and then both wire glands are tightened. This produces a gas and moisture tight high voltage wire splice.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A low cost gas and water tight high voltage electrical connector device for imbedding into a potted high voltage generating device, comprising of:
(a) an elongated electrically insulated tubular body mounted on an electrical device panel, having an exposed end and an end embedded within said electrical device panel;
(b) an insulated liquid tight pass-through cord grip wire gland located on the exposed end of said tubular body, thereby exposed outside of the panel; and
(c) an electrically conductive female contact imbedded into the inside of the connector, located on the embedded end;
whereby the electrical connector is intended to electrically connect a high voltage wire to a high voltage generating device, accommodating the connection of high voltage wires of varying diameters.

2. A low cost gas and water tight high voltage electrical connector device for imbedding into a potted high voltage generating device according to claim 1, wherein high voltage wires of varying diameter are inserted into and through said liquid tight pass-through cord grip wire gland such that the exposed and un-insulated end of the inserted high voltage wire makes contact with the imbedded electrically conductive female contact.

3. A low cost gas and water tight high voltage electrical connector device for imbedding into a potted high voltage generating device according to claim 1, wherein high voltage wires of varying diameter are inserted into and through said liquid tight pass-through cord grip wire gland, and further wherein the inserted high voltage wire has a crimped pin attached thereto and said crimped pin makes contact with the imbedded female contact.

4. A low cost gas and water tight high voltage electrical connector device for imbedding into a potted high voltage generating device according to claim 1, wherein high voltage wires of varying diameter are inserted into and through said liquid tight pass-through cord grip wire gland, and further wherein the inserted high voltage wire has a soldered pin attached thereto and said soldered pin makes contact with the imbedded female contact.

5. A low cost gas and water tight high voltage electrical connector device for imbedding into a potted high voltage generating device according to claim 1, wherein the length and wall thickness of the elongated electrically insulated tubular body will vary in thickness and length depending upon the intended maximum voltage to be conducted through the high voltage electrical connector.

6. A low cost gas and water tight high voltage electrical connector device for imbedding into a potted high voltage generating device according to claim 1, wherein said end embedded within said electrical device panel is embedded in potting material and further wherein only liquid tight pass-through cord grip wire gland is exposed external to the panel.

7. A low cost gas and water tight high voltage electrical connector device for connection to a high voltage wire on one end as a flying lead, comprising of:
(a) an elongated electrically insulated tubular body having a proximal and distal end wherein said proximal end is attached to a high voltage wire as a flying lead;
(b) an insulated liquid tight pass-through cord grip wire gland is located on the distal end of said tubular body; and
(c) an electrically conductive female contact is imbedded into the inside of the insulated tubular body at the proximal end;
whereby the electrical connector is intended to electrically connect a high voltage wire to a high voltage wire, accommodating the connection of high voltage wires of varying diameters.

8. A low cost gas and water tight high voltage electrical connector device for connection to a high voltage wire on one end as a flying lead according to claim 7, wherein said electrically conductive female contact imbedded into the inside of the insulated tubular body at the proximal end is co-molded into the insulated tubular body to form an integral unit, whereby the high voltage wire is permanently connected to the proximal end of the insulated tubular body.

9. A low cost gas and water tight high voltage electrical connector device for connection to a high voltage wire on one end as a flying lead according to claim 7, wherein high voltage wires of varying diameter are inserted into and through said liquid tight pass-through cord grip wire gland such that the exposed and un-insulated end of the inserted high voltage wire makes contact with the imbedded electrically conductive female contact.

10. A low cost gas and water tight high voltage electrical connector device for connection to a high voltage wire on one end as a flying lead according to claim 7, wherein high voltage wires of varying diameter are inserted into and through said liquid tight pass-through cord grip wire gland, and further wherein the inserted high voltage wire has a crimped pin attached thereto and said crimped pin makes contact with the imbedded female contact.

11. A low cost gas and water tight high voltage electrical connector device for connection to a high voltage wire on one end as a flying lead according to claim 7, wherein high voltage wires of varying diameter are inserted into and through said liquid tight pass-through cord grip wire gland, and further wherein the inserted high voltage wire has a soldered pin attached thereto and said soldered pin makes contact with the imbedded female contact.

12. A stand-alone unit low cost gas and water tight high voltage electrical connector device for connecting one high voltage wire to another high voltage wire, comprising:
(a) an elongated electrically insulated tubular body having a proximal end and distal end;
(b) an insulated liquid tight pass-through cord grip wire gland located on the proximal end said insulated tubular body; and
(c) an insulated liquid tight pass-through cord grip wire gland located on the distal end said insulated tubular body;
whereby the electrical connector is intended to electrically connect one high voltage wire to another high voltage wire, via a wire splice connector located internal to said insulated tubular body, thereby accommodating the connection of high voltage wires of varying diameters.
whereby two high voltage wires may be field spliced together and sealed within the tube.

13. A stand-alone unit low cost gas and water tight high voltage electrical connector device for connecting one high voltage wire to another high voltage wire according to claim 12, wherein dielectric grease is used inside the tubular body for added dielectric and corona withstanding properties.

14. A method for making low cost gas and water tight high voltage electrical connector device for imbedding into a potted high voltage generating device, comprising the steps of:
(a) providing an elongated electrically insulated tubular body mounted on an electrical device panel, having an exposed end and an end embedded within said electrical device panel;
(b) providing an insulated liquid tight pass-through cord grip wire gland located on the exposed end of said tubular body, thereby exposed outside of the panel; and
(c) providing an electrically conductive female contact imbedded into the inside of the connector, located on the embedded end;
whereby the electrical connector is intended to electrically connect a high voltage wire to a high voltage generating device, accommodating the connection of high voltage wires of varying diameters.

15. The method for making a high voltage wire connector device, according to claim 14, further including the step of:
embedding said end embedded within said electrical device panel in potting material; and
further wherein only liquid tight pass-through cord grip wire gland is exposed external to the panel.

16. The method for using a high voltage wire connector device, constructed according to claim 14, wherein high voltage wires of varying diameter are inserted into and through said liquid tight pass-through cord grip wire gland such that the exposed and un-insulated end of the inserted high voltage wire makes contact with the imbedded electrically conductive female contact.

17. The method for using a high voltage wire connector device, constructed according to claim 16, wherein high voltage wires of varying diameter are inserted into and through said liquid tight pass-through cord grip wire gland, and further wherein the inserted high voltage wire has a crimped pin attached thereto and said crimped pin makes contact with the imbedded female contact.

18. The method for using a high voltage wire connector device, constructed according to claim 16, wherein high voltage wires of varying diameter are inserted into and through said liquid tight pass-through cord grip wire gland, and further wherein the inserted high voltage wire has a soldered pin attached thereto and said soldered pin makes contact with the imbedded female contact.

19. The method for making a high voltage wire connector device, according to claim 14, wherein said step of providing an elongated electrically insulated tubular body mounted on an electrical device panel, further includes the step of varying the length and thickness of said insulated tubular body depending upon the intended maximum voltage to be conducted through the high voltage electrical connector.

20. The method for making a high voltage wire connector device, according to claim 14, wherein said step of providing an electrically conductive female contact imbedded into the inside of the connector, located on the embedded end, further includes the step of co-molding said female contact into said insulated tubular body.
